(19) United States
(12) Patent Application Publication
(10) Pub. No.: US 2014/0095635 A1
(43) Pub. Date: Apr. 3, 2014

(54) OPERATION-ASSISTING APPARATUS, OPERATION-ASSISTING METHOD, AND RECORDING MEDIUM CONTAINING CONTROL PROGRAM

(71) Applicant: SHARP KABUSHIKI KAISHA, Osaka (JP)

(72) Inventors: Yoshiharu Yoshimoto, Osaka-shi (JP); Takayuki Nagamatsu, Osaka-shi (JP); Minako Kuwata, Osaka-shi (JP); Chie Hideishi, Osaka-shi (JP); Makoto Sakuta, Osaka-shi (JP)

(73) Assignee: SHARP KABUSHIKI KAISHA, Osaka (JP)

(21) Appl. No.: 14/027,841

(22) Filed: Sep. 16, 2013

(30) Foreign Application Priority Data
Oct. 1, 2012 (JP) 2012-219841

(51) Int. Cl. H04L 12/58

(52) U.S. Cl. CPC H04L 51/046
USPC 709/206

(57) ABSTRACT

An agent server includes: a conversational message determining section which determines a conversational message to a message on a family message board; an appliance-related message determining section which obtains operation-assisting information for a domestic appliance according to the message; and a message transmitting section which causes the conversational message and the operation-assisting information to be written on the family message board.

This Nonprovisional application claims priority under 35 U.S.C. §119 on Patent Application No. 2012-219841 filed in Japan on Oct. 1, 2012, the entire contents of which are hereby incorporated by reference.

### TECHNICAL FIELD

The present invention relates to assistance in communication through a communications network.

### BACKGROUND ART

Conventionally, services that provide communication through communications networks such as an electronic bulletin board, a chat, and an SNS (social networking service) have reached masses, and various technologies relating to these services have been proposed.

For example, Patent Literature 1, listed below, discloses a server apparatus that facilitates a chat by allowing a conversation program that serves as a chat partner with a user to participate in the chat.

Further, in recent years, it has become possible to manage household electrical appliances on a home server and remotely control the household electrical appliances through the home server. For example, Patent Literature 2, listed below, discloses the transmission to a server of usage information on the usage of a household electrical appliance, the creation of consulting information by the server on the basis of the usage information, and the transmission of the consulting information to a home server. Moreover, Patent Literature 2 discloses that the home server causes an image to be displayed which recommends operating the household electrical appliance on the basis of the consulting information, transmits the consulting information to the household electrical appliance in accordance with an operation performed by a user who looked at the image, and causes the household electrical appliance to operate accordingly.

### CITATION LIST

Patent Literature 1
Japanese Patent Application Publication, Tokukai, No. 2002-099494 A (Publication Date: Apr. 5, 2002)
Patent Literature 2
Japanese Patent Application Publication, Tokukai, No. 2012-109995 A (Publication Date: Jun. 7, 2012)

### SUMMARY OF INVENTION

### Technical Problem

However, in the case of the technology of Patent Literature 1, an attempt to remotely control a household electrical appliance during a chat requires interruption of communication for access to a home server.

Further, since the technology of Patent Literature 2 recommends operating a household electrical appliance in accordance with usage information, it is not always possible to operate a household electrical appliance in accordance with the intent of a user who is performing communication through a communications network.

The present invention has been made in view of the foregoing problems, and it is an object of the present invention to provide an operation-assisting apparatus which makes it possible to present, to a user partaking in communication through a communications network, a response message in line with the content of the communication and to easily operate an electronic appliance in line with the content of the communication.

### Solution to Problem

In order to solve the foregoing problems, an operation-assisting apparatus according to an aspect of the present invention is an operation-assisting apparatus for assisting operation of an electronic appliance associated with a user of a communications network service that presents a message from a member of a group to another member of the group, including: responding means for determining a response message to a target-of-presentation message that is a target of presentation in the service; operation-assisting means for obtaining, according to the target-of-presentation message, operation-assisting information for assisting the operation of the electronic appliance; and presenting means for causing the response message and the operation-assisting information to be presented to the user on a same screen as the target-of-presentation message.

Further, in order to solve the foregoing problems, an operation-assisting method according to an aspect of the present invention is an operation-assisting method that is employed by an operation-assisting apparatus for assisting operation of an electronic appliance associated with a user of a communications network service that presents a message from a member of a group to another member of the group, including: a response determining step of determining a response message to a target-of-presentation message that is a target of presentation in the service; an operation-assisting information obtaining step of obtaining, according to the target-of-presentation message operation-assisting information for assisting the operation of the electronic appliance; and a presenting step of causing the response message and the operation-assisting information to be presented to the user on a same screen as the target-of-presentation message.

### Advantageous Effects of Invention

The operation-assisting apparatus and the operation-assisting method according to an aspect of the present invention bring about an effect of making it possible to present a response message in line with a target-of-presentation message and to easily operate an electronic appliance in line with the target-of-presentation message.

### BRIEF DESCRIPTION OF DRAWINGS

FIG. 1 is a block diagram showing an example of a configuration of a main part of an agent server according to an embodiment of the present invention.

FIG. 2 is a diagram showing an overall structure of a family message board system including the agent server.

FIG. 3 is a diagram showing an example screen image of a family message board where a conversational message generated by the agent server is displayed.

FIG. 4 is a diagram showing examples of data stored in a memory section for the agent server to cause the conversational message to be displayed in the example shown in FIG. 3.

FIG. 5 is a diagram showing an example screen image of the family message board where a conversational message and an appliance-related message both generated by the agent server are displayed.

FIG. 6 is a diagram showing examples of data stored in the memory section for the agent server to cause the conversational message to be displayed in the example shown in FIG. 5.

FIG. 7 is a diagram showing an example screen transition concerning a display of operation-assisting information.

FIG. 8 is a diagram showing examples of data stored in the memory section for the agent server to cause the display of the example shown in FIG. 7 to be performed.

FIG. 9 is a diagram showing another example screen transition concerning a display of operation-assisting information.

FIG. 10 is a diagram showing still another example screen transition concerning a display of operation-assisting information.

FIG. 11 is a diagram showing an example screen transition concerning a display of operation-assisting information on a video recorder.

FIG. 12 is a diagram showing examples of data stored in the memory section for the agent server to cause the display of the example shown in FIG. 11 to be performed.

FIG. 13 is a diagram showing an example screen transition concerning a display of operation-assisting information on an appliance capable of making alarm sounds at a designated time.

FIG. 14 is a diagram showing examples of data stored in the memory section for the agent server to cause the display of the example shown in FIG. 13 to be performed.

FIG. 15 is a flow chart showing an example of a process that the agent server executes.

### DESCRIPTION OF EMBODIMENTS

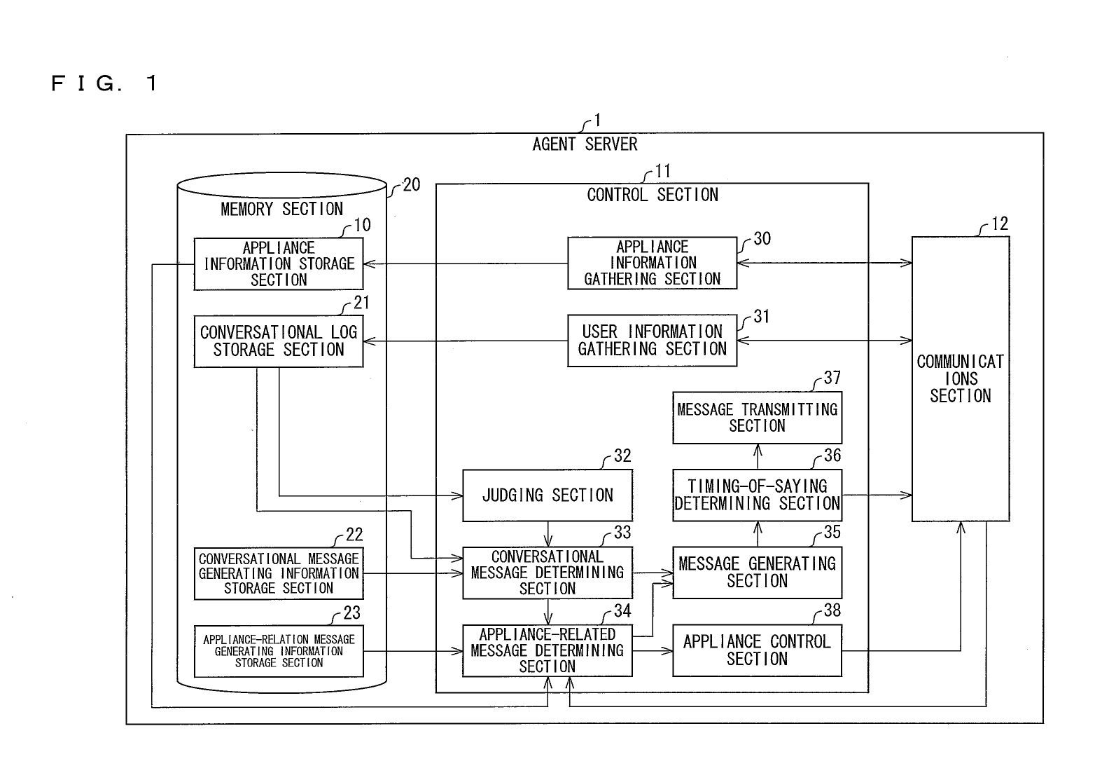

An embodiment of the present invention is described in detail below with reference to FIGS. 1 through 15.

[Overall Structure of a Family Message Board System]

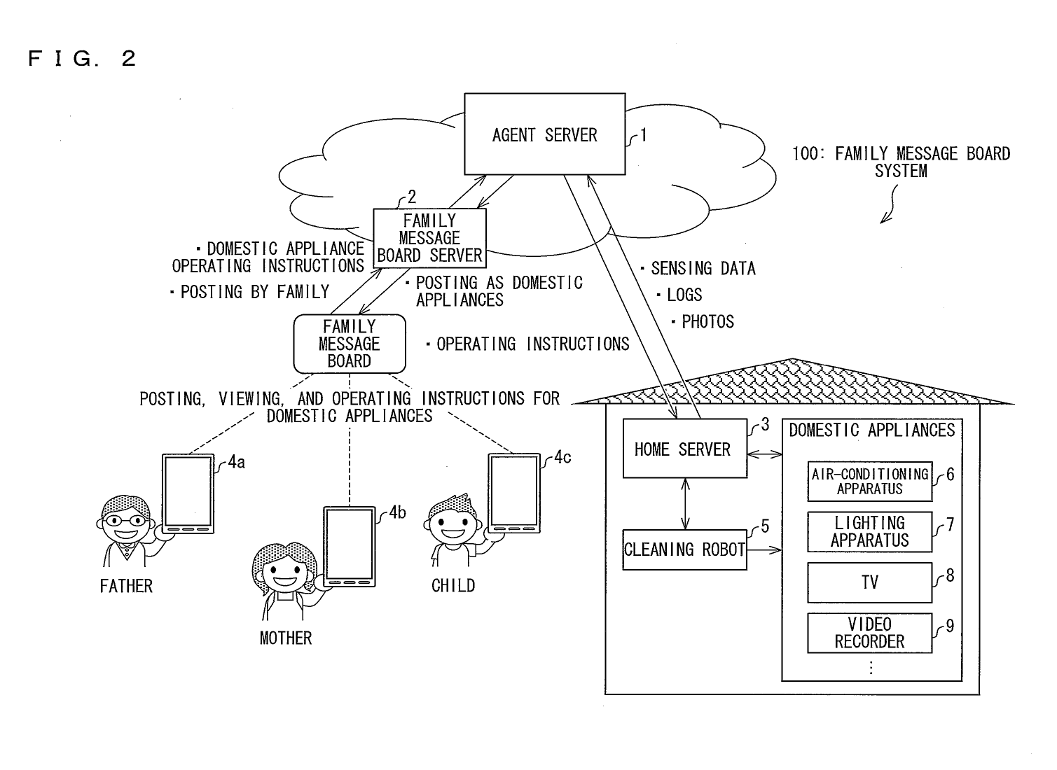

First, an overall structure of a family message board system according to an embodiment of the present invention is described with reference to FIG. 2. FIG. 2 is a diagram showing an overall structure of a family message board system 100.

The family message board system 100 is a system that provides an electronic message board for communication among members of a registered group. Further, in the family message board system 100, postings are put on a family message board in accordance with the states of appliances (hereinafter referred to as “domestic appliances”) disposed in a home, the content of messages written by the members, etc. Furthermore, in the family message board system 100, the operation of the domestic appliances is controlled in accordance with instructions from the members.

As shown in FIG. 2, the family message board system 100 includes an agent server (operation-assisting apparatus) 1, a family message board server 2, and a home server 3. Members of a family (in the example shown in FIG. 2, father, mother, and child) can access the family message board with their portable terminals 4a, 4b, and 4c to put postings on the family message board, view the family message board, and give operating instructions for the domestic appliances. Further, there is a cleaning robot (electronic appliance) 5 communicably connected wirelessly to the home server 3, and the domestic appliances (electronic appliances) are communicably connected by wire or wirelessly to the home server 3. In the example shown in FIG. 2, the domestic appliances are an air-conditioning apparatus 6, a lighting apparatus 7, a TV 8, and a video recorder 9. However, types of domestic appliances and the number of domestic appliances are not particularly limited.

The agent server 1 puts postings on the family message board in accordance with the states of the domestic appliances, information obtained by the domestic appliances, the content of postings put by the members, etc. More specifically, the agent server 1 put postings as a character as which the cleaning robot 5 is personified. This allows the members of the family to have a simulated experience of communication with the cleaning robot 5 on the family message board.

Further, the agent server 1 receives operating instructions from the portable terminals 4a, 4b, and 4c, and transmits, to the home server 3, operating instructions corresponding to these received operating instructions, thereby controlling the operation of the cleaning robot 5 or any of the domestic appliances.

In the example described here, the agent server 1 has both the function of putting postings on the family message board and the function of controlling the operation of the cleaning robot 5 and the domestic appliances. However, these functions may be mounted on separate servers.

The family message board server 2 presents display screen images of the family message board to the portable terminals 4a, 4b, and 4c and performs all aspects of processes concerning the family message board, such as management of postings.

The home server 3 has overall control over exchange of information between the cleaning robot 5 or the domestic appliances and the agent server 1. Specifically, the home server 3 controls the operation of the cleaning robot 5 or the domestic appliances in accordance with operating instructions received from the agent server 1. Further, the home server 3 transmits, to the agent server 1, information obtained from the cleaning robot 5 and information obtained from the domestic appliances.

In the example shown in FIG. 2, the home server 3 transmits sensing data obtained by a sensor(s) mounted in the cleaning robot 5 or in the domestic appliances, logs of operations of the domestic appliances, and photographs taken by the domestic appliances. However, the information that the home server 3 transmits is not limited to these examples.

Alternatively, in a case where there is no need for overall control, such as a case where there is no domestic appliance involved in the family message board, the family message board system 100 may be configured without the home server 3 such that the cleaning robot 5 exchange information with the agent server 1.

The portable terminals 4a, 4b, and 4c are devices for viewing the family message board, putting postings on the family message board, and for giving operating instructions for the domestic appliances. In the example shown in FIG. 2, the portable terminals 4a, 4b, and 4c are smartphones. However, the portable terminals 4a, 4b, and 4c are not so limited, provided that they make it possible to view the family message board, put postings on the family message board, and give operating instructions.

The cleaning robot 5 is a self-propelled cleaner that automatically cleans a floor. Further, in addition to the cleaning function, the cleaning robot 5 has a function of storing a log of operations, a function of detecting and outputting a remaining amount of charge, an image-taking function, a speech recognition function, an audio output function, etc. Furthermore, the cleaning robot 5 also has a function of operating the domestic appliances by transmitting control signals to them.

The air-conditioning apparatus 6 is an apparatus that performs air conditioning such as cooling or heating, and is a so-called air conditioner. Further, the air-conditioning apparatus 6 includes a temperature sensor, and transmits, to the home server 3, a room temperature detected by the temperature sensor.

The lighting apparatus 7 is a lighting apparatus including a light source such as an LED, and can be turned on and off under the control of the home server 3.

The TV 8 is a television receiver, and the video recorder 9 is an apparatus that records a broadcast program received by the TV 8. These appliances, too, can be operated under the control of the home server 3.

[Configuration of the Agent Server]

In the following, a configuration of the agent server is described in more detail with reference to FIG. 1. FIG. 1 is a block diagram showing an example of a configuration of a main part of the agent server 1. As shown in FIG. 1, the agent server 1 includes a memory section 20, a control section 11, and a communications section 12.

The memory section 20 is a memory device in which various types of data are stored for use by the agent server 1. As shown in FIG. 1, the memory section 20 includes an appliance information storage section 10, a conversational log storage section 21, a conversational message generating information storage section 22, and an appliance-related message generating information storage section 23.

In the appliance information storage section 10, information concerning the domestic appliances and the cleaning robot 5 is stored. Further, in the conversational log storage section 21, a conversational log(history of postings) is stored.

Stored in the conversational message generating information storage section 22 is information for determining a message from the agent server 1 in accordance with what is being said on the family message board. Further stored in the appliance-related message generating information storage section 23 is information for determining a message concerning any of the domestic appliances or the cleaning robot 5 that is to be written on the family message board. These items of information will be described in detail later.

The control section 11 has overall control over the functions of the agent server 1. As shown in FIG. 1, the control section 11 includes an appliance information gathering section (state obtaining means) 30, a user information gathering section 31, a judging section 32 for judging whether or not it is permissible to say words, a conversational message determining section (responding means) 33, an appliance-related message determining section 34, a message generating section (operation-assisting means) 35, a timing-of-saying determining section 36, a message transmitting section (presenting means) 37, and an appliance control section 38.

The appliance information gathering section 30 gathers information concerning the cleaning robot 5 and the domestic appliances, and stores the information in the appliance information storage section 10. Specifically, the appliance information gathering section 30 obtains information indicative of the states of areas around the appliances, as obtained by the sensors provided in the cleaning robot 5 and the domestic appliances, and information indicative of the states of the cleaning robot 5 and the domestic appliances per se.

The user information gathering section 31 gathers information concerning a user of a family message board service. Specifically, the user information gathering section 31 obtains a conversational log of each member registered as one group in the family message board server 2, and stores, in the conversational log storage section 21, the conversational log thus obtained.

The judging section 32 judges whether or not it is permissible to say words on the family message board. Specifically, in a case where none of the members is using the family message board, the judging section 32 judges that it is impermissible to say words.

The conversational message determining section 33 determines, in accordance with what is being said on the family message board, a conversational message that is to be written on the family message board. The term “conversational message” here means a response message to a message written by a member which, among other messages that the agent server 1 writes on the family message board, is determined on the basis of the information stored in the conversational log storage section 21. How a conversational message is determined will be described later.

The appliance-related message determining section 34 determines an appliance-related message that is to be written on the family message board. The term “appliance-related message” here means a message which, among other messages that the agent server 1 writes on the family message board, relates to any of the domestic appliances or the cleaning robot 5. How an appliance-related message is determined will be described later.

The message generating section 35 combines a conversational message determined by the conversational message determining section 33 and an appliance-related message determined by the appliance-related message determining section 34 to generate a message that is to be written on the family message board.

The timing-of-saying determining section 36 determines the timing of writing of a message generated by the message generating section 35. How a timing of saying is determined will be described later.

The message transmitting section 37 transmits a message generated by the message generating section 35 to the family message board server 2 at a timing determined by the timing-of-saying determining section 36, thereby causing the message to be written on the family message board so that the message is presented to the members.

The appliance control section 38 controls the operation of the cleaning robot 5 and the domestic appliances through the home server 3.

The communications section 12 allows the agent server 1 to communicate with an external device. Specifically, the agent server 1 communicates with the family message board server 2 and the home server 3 through the communications section 12.

[Example of how a Conversational Message is Generated]

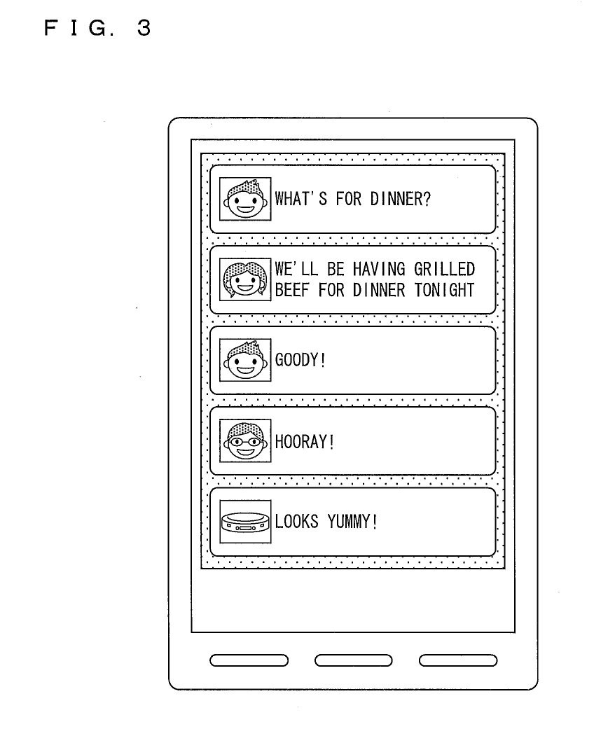

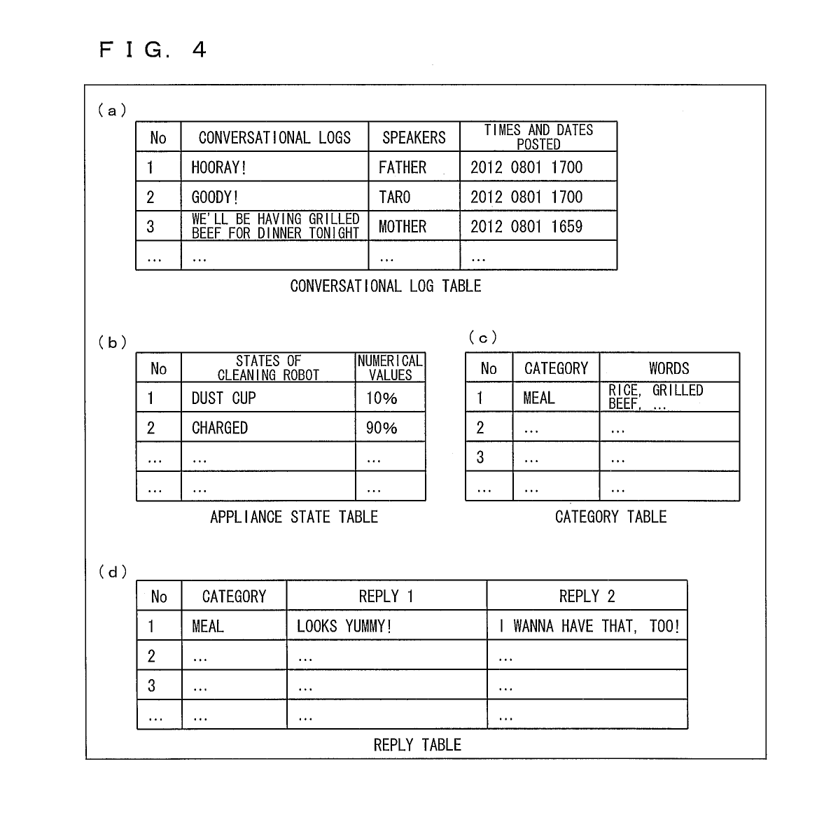

Next, an example of how a conversational message is generated from a conversational log is described with reference to FIGS. 3 and 4. FIG. 3 is a diagram showing an example screen image of the family message board where a conversational message generated by the agent server 1 is displayed. Further, FIG. 4 is a diagram showing examples of data stored in the memory section 20 for the agent server 1 to cause the conversational message to be displayed in the example shown in FIG. 3.

In the example shown in FIG. 3, the messages written on the family message board are arranged in descending chronological order. Further, each of the messages is displayed in association with information indicative of its writer, specifically with an icon corresponding to the writer.

In FIG. 3, the conversational message generated by the agent server 1 is displayed with an icon of the cleaning robot 5 as information indicative of the writer. However, this does not imply any limitation. For example, as in the case of the domestic appliances and the home server 3, an icon of another appliance that exists in the user's home may be displayed. This allows the user to enjoy virtual communication with the cleaning robot 5, any of the domestic appliances, or the home server 3. The information indicative of the writer does not necessarily have to be an icon, provided that it allows the members to identify the writer.

(a) of FIG. 4 shows an example of a conversational log table stored in the conversational log storage section 21, and (b) of FIG. 4 shows an example of an appliance state table stored in the appliance information storage section 10. Further, (c) of FIG. 4 shows an example of a category table stored in the conversational message generating information storage section 22, and (d) of FIG. 4 shows an example of a reply table stored in the conversational message generating information storage section 22.

In the example shown in FIG. 3, the father, the mother, and the child write messages, whereby these messages written are recorded as conversational logs in the family message board server 2. Then, the user information gathering section 31 obtains these conversational logs, and stores them in the conversational log storage section 21 in the form of such a conversational log table as that shown in (a) of FIG. 4. In the example shown in (a) of FIG. 4, a conversational log indicative of the concrete content of a message, the speaker who posted the message, and the time and date the message was posted are associated with one another. In (a) of FIG. 4, the name “TARO” corresponds to the “child”.

Further, the appliance information gathering section 30 gathers information concerning the states of the cleaning robot 5 and stores such an appliance state table as that shown in (b) of FIG. 4 in the appliance information storage section 10. In the example shown in (b) of FIG. 4, the states of the cleaning robot 5 are described by combinations of characters and numerical values.

Specifically, the association of “10%” with “DUST CUP” indicates that dust has been collected to 10% of the maximum capacity of the dust cup. It should be noted that the dust cup is a component of the cleaning robot 5 in which dust sucked up by the cleaning robot 5 is collected. Similarly, the association of “90%” with “CHARGED” indicates that the cleaning robot 5 is on 90% of a full charge.

The appliance-related message determining section 34 generates an appliance-related massage with reference to such an appliance state table. However, in such a case as that shown in (b) of FIG. 4 where the amount of dust collected is small and the cleaning robot 5 is on a sufficient charge, the appliance-related message determining section 34 judges that it is unnecessary to generate an appliance-related message. In this case, only a conversational message is written with no appliance-related message written, as in the example shown in FIG. 3.

The category table shown in (c) of FIG. 4 is a table for identifying a category of conversation, in which words and categories are associated with each other. The conversational message determining section 33 uses this category table to identify a category of conversation from a word contained in a message of a conversational log.

Specifically, since the word “GRILLED BEEF” is contained in the message “WE'LL BE HAVING GRILLED BEEF FOR DINNER TONIGHT” in the conversational table shown in (a) of FIG. 4, the conversational message determining section 33 identifies this conversation as relating to “MEAL” from the category table shown in (c) of FIG. 4.

The reply table shown in (d) of FIG. 4 is a table for determining a message according to a category of conversation, in which categories and messages are associated with each other. Specifically, the message “LOOKS YUMMY!” and the message “I WANNA HAVE THAT, TOO!” are associated with the category “MEAL”.

This allows the conversational message determining section 33 to identify the messages “LOOKS YUMMY!” and “I WANNA HAVE THAT, TOO!” from the reply table shown in (d) of FIG. 4 when having judged the category of conversation as “MEAL” from the category table shown in (c) of FIG. 4.

Moreover, in a case where the conversational message determining section 33 has determined the message “LOOKS YUMMY!”, among these messages, as a message that is to be written, such a message as that shown in FIG. 3 is written. It should be noted that the number of messages that are associated with a single category may be 1 or not less than 3.

[Example of how a Conversational Message and an Appliance-related Message Are Generated]

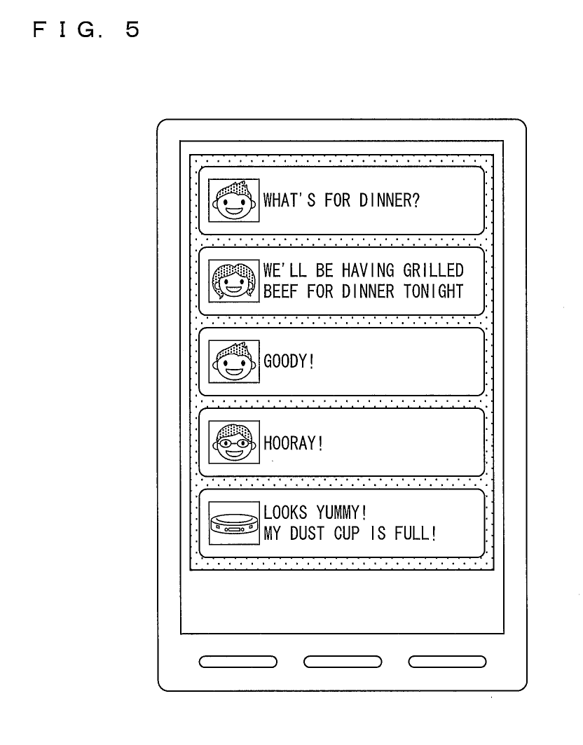

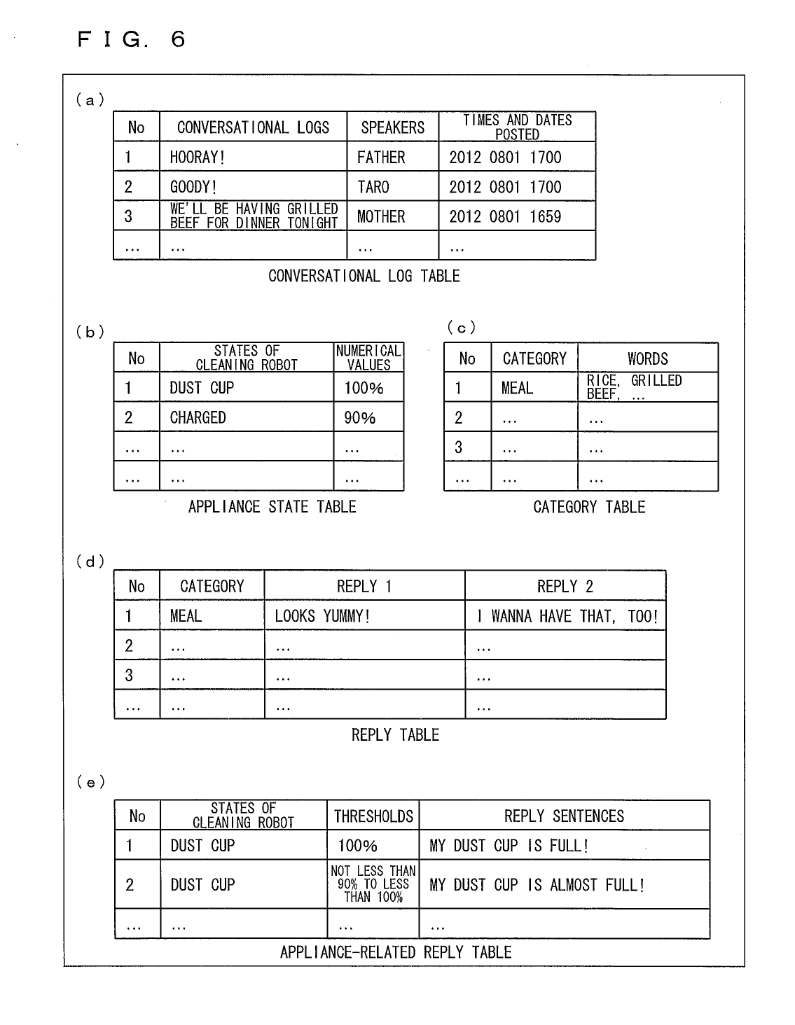

Next, an example of how a conversational message and an appliance-related message are generated is described with reference to FIGS. 5 and 6. FIG. 5 is a diagram showing an example screen image of the family message board where a conversational message and an appliance-related message both generated by the agent server 1 are displayed. FIG. 6 is a diagram showing examples of data stored in the memory section 20 for the agent server 1 to cause the conversational message to be displayed in the example shown in FIG. 5.

In the example shown in FIG. 5, the father, the mother, and the child write the same messages as those written in the example shown in FIG. 3. As in the example shown in FIG. 3, the message “LOOKS YUMMY!” is written together with the icon of the cleaning robot 5. The example shown in FIG. 5, however, differs from the example shown in FIG. 3 in that the message “LOOKS YUMMY!” is followed by a message “MY DUST CUP IS FULL!”.

(a), (c), and (d) of FIG. 6 are identical to (a), (c), and (d) of FIG. 4, respectively. Therefore, in the example shown in FIG. 5, the conversational message “LOOKS YUMMY!” is written, as in the example shown in FIG. 3.

Meanwhile, the appliance state table shown in (b) of FIG. 6 differs from the example shown in (b) of FIG. 4 in that “DUST CUP” is associated with a numerical value “100%”. Further, (e) of FIG. 6 shows an appliance-related reply table which is data stored in the appliance-related message generating information storage section 23 and which is not shown in the example shown in FIG. 4.

The appliance-related reply table is a table for determining a message according to appliance information, in which the states and thresholds of the cleaning robot 5 and messages are associated with one another. Specifically, the message (state-related message) “MY DUST CUP IS FULL!” is associated with a threshold (100%) for “DUST CUP”. Further, a message (state-related message) “MY DUST CUP IS ALMOST FULL!” is associated with a threshold (not less than 90% to less than 100%) for “DUST CUP”.

This allows the appliance-related message determining section 34 to identify the message “MY DUST CUP IS FULL!” in the appliance-related reply table from a numerical value associated with “DUST CUP” in the appliance state table shown in (b) of FIG. 6 and a threshold associated with “DUST CUP” in the appliance-related reply table shown in (e) of FIG. 6.

Then, the message generating section 35 generates a message by combining the message “LOOKS YUMMY!” determined by the conversational message determining section 33 and the message “MY DUST CUP IS FULL!” determined by the appliance-related message determining section 34. This causes the conversational message and the state-related message to be displayed on the same screen as those written by the members, as shown in FIG. 5.

[Example Presentation 1 of Operation-Assisting Information]

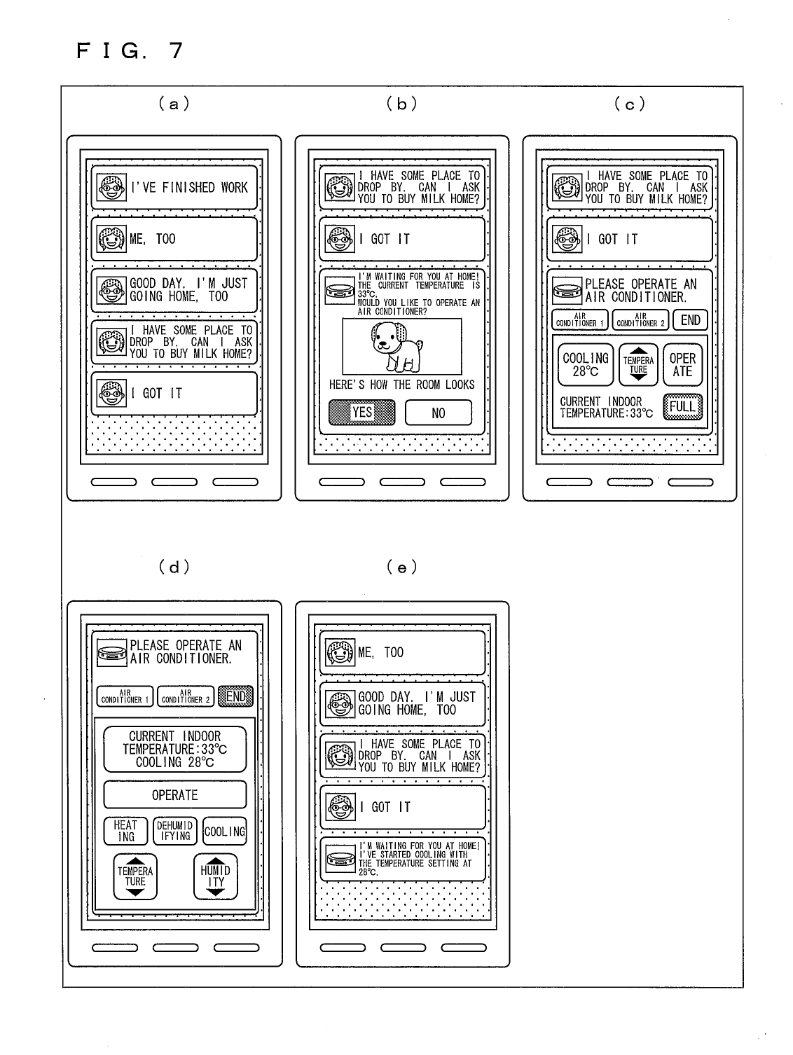

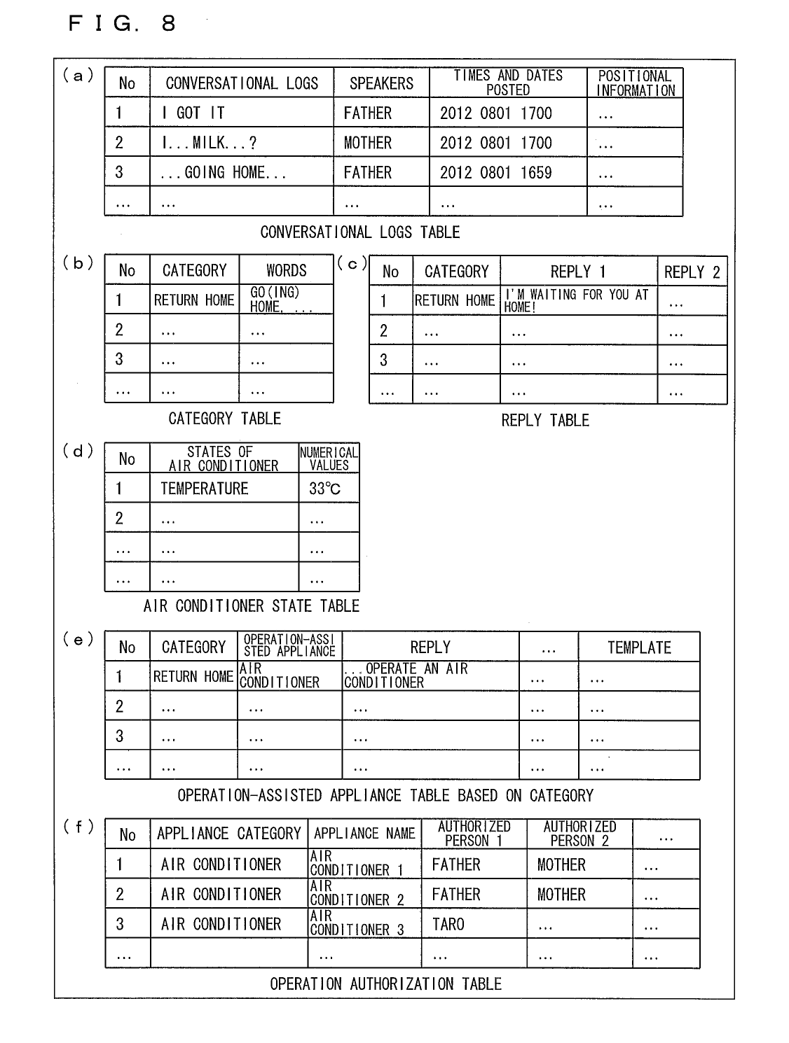

Next, an example of how operation-assisting information for assistance in operation of a domestic appliance is displayed is described with reference to FIGS. 7 and 8. FIG. 7 is a diagram showing an example screen transition concerning a display of operation-assisting information. FIG. 8 is a diagram showing examples of data stored in the memory section 20 for the agent server 1 to cause the display of the example shown in FIG. 7 to be performed.

In an example screen image shown in (a) of FIG. 7, the father and the mother are having a conversation with each other on the family message board about the their going home from the places where they have gone to, respectively. The content (messages, the speakers who posted the messages, and the times and dates the messages were posted) of this conversation is stored in the conversational log storage section 21 in the form of such a conversational log table as that shown in (a) of FIG. 8.

In the conversational log table shown in (a) of FIG. 8, each log is associated with positional information indicative of the position of the speaker. For example, such positional information may be obtained through the family message board server 2 by a GPS receiver provided in the portable terminal of the speaker.

Since a phrase “GO(ING) HOME” is contained in a conversational log in the conversational log table, it can be judged, with reference to a category table shown in (b) of FIG. 8, that the ongoing conversation falls under a category “RETURN HOME”.

However, it might be the case that a person who put a posting containing the phrase “GO(ING) HOME” is at home. In such a case, it is not appropriate to write a conversational message that falls under the category “RETURN HOME”.

In preparation for such a case, the conversational message determining section 33 judges, with reference to the positional information in the conversational log table, whether a person who put a posting containing the phrase “GO(ING) HOME” is at home. Then, in a case where the conversational message determining section 33 judges that he/she is not at home, it randomly extracts a reply message falling under the category “RETURN HOME” from a replay table shown in (c) of FIG. 8. This causes a conversational message such as “I'M WAITING FOR YOU AT HOME!” shown in (b) of FIG. 7 to be displayed.

Alternatively, in a case where the conversational message determining section 33 has judged that he/she is at home, it does not extract a reply message falling under the category “RETURN HOME”. With such a configuration that a conversational message is written in consideration of positional information, a conversational message falling under the category “RETURN HOME” can be written when it is highly likely to be the case that he/she is going home from the place where he/she has gone to.

Further, the appliance-related message determining section 34 identifies an operation-assisted appliance according to the category with reference to an operation-assisted appliance table shown in (e) of FIG. 8. In the operation-assisted appliance table shown in (e) of FIG. 8, categories, operation-assisted appliances, reply messages, and templates containing operation-assisting information for assisting the operation of the operation-assisted appliances are associated with one another. Since, in this operation-assisted appliance table, “AIR CONDITIONER” (air-conditioning apparatus 6) is registered as “OPERATION-ASSISTED APPLIANCE” in the category “RETURN HOME”, the appliance-related message determining section 34 determines an air conditioner an operation-assisted appliance.

Next, the appliance-related message determining section 34 judges, with reference to appliance information stored in the appliance information stored in the appliance information storage section 10, whether or not it is necessary to generate an appliance-relation message. Since the operation-assisted appliance here is an air conditioner, the appliance-related message determining section 34 refers to such an air-conditioner state table as that shown in (d) of FIG. 8 as appliance information. Further, the appliance-related message determining section 34 also refers to a photograph taken of the room by the cleaning robot 5 and stored in the appliance information storage section 10.

The air-conditioner state table shown in (d) of FIG. 8 shows states and numerical values concerning an air conditioner, specifically showing that the temperature measured by the sensor of the air conditioner is 33° C. The appliance-related message determining section 34 judges, from this temperature, whether or not it is necessary to operate the air conditioner. More specifically, in a case where the temperature is out of a predetermined range (the temperature is high to the extent that cooling is necessary or the temperature is low to the extent that heating is necessary), the appliance-related message determining section 34 judges that it is necessary to operate the air conditioner. Alternatively, in a case where the temperature falls within the predetermined range, the appliance-related message determining section 34 judges that it is not necessary to operate the air conditioner.

Further, the photograph taken of the room by the cleaning robot 5 is a photograph taken most recently among other photographs taken by the cleaning robot 5. Let it be assumed that a dog was in the photograph as shown in (b) of FIG. 7.

In this case, the appliance-related message determining section 34 judges, by performing an image analysis of the photograph, that there is a dog (pet) in the room. It should be noted that the image analysis may be performed by a processing section, such as the appliance information gathering section 30, separately from the appliance-related message determining section 34, or may be performed by a device provided outside the agent server 1.

Furthermore, the appliance-related message determining section 34 judges, from the positional information in the conversational log table shown in (a) of FIG. 8, that the persons who are partaking in conversation with each other are in the places where they have gone to, respectively (i.e., are not at home). It should be noted that in a case where it is judged, in consideration of the positional information, that the ongoing conversation falls under the category “RETURN HOME”, it is not necessary to make another judgment based on the conversational log table.

As described above, the appliance-related message determining section 34 judges that the indoor temperature is high, that there is a pet in the room, and that the persons who are partaking in conversation with each other are in the places where they have gone to, respectively. Then, in accordance with these results of judgment, the appliance-related message determining section 34 determines for the operation of the air conditioner to be assisted.

The appliance-related message determining section 34, which has determined for the operation of the air conditioner to be assisted, extracts, from the operation-assisted appliance table shown in (e) of FIG. 8, a reply message associated with “AIR CONDITIONER” and a template for choosing whether or not to operate an air conditioner, and transmits the reply message and the template to the message generating section 35. Further, the appliance-related message determining section 34 obtains, from the appliance information storage section 10, the photograph taken of the room by the cleaning robot 5, and transmits the photograph to the message generating section 35.

Then, the message generating section 35 arranges the conversational message, the appliance-related messages, and the photograph on the template for choosing whether or not to operate an air conditioner, and instructs the message transmitting section 37 to cause the conversational message, the appliance-related messages, and the photograph to be posted in this layout. It should be noted that a template containing objects “YES” and “NO” may be prepared in the family message board server 2. In this case, it is only necessary to designate the template and give an instruction so that the conversational message, the appliance-related messages, and the photograph are displayed.

As a result, as shown in (b) of FIG. 7, a template having the following items (1) to (3) arranged thereon is displayed on the family message board: (1) the conversational message “I'M WAITING FOR YOU AT HOME!”; (2) the appliance-related messages “THE CURRENT TEMPERATURE IS 33° C.” and “WOULD YOU LIKE TO OPERATE AN AIR CONDITIONER?”; and (3) the photograph of the way the room looks. This template contains the objects (operation-assisting information) “YES” and “NO” for choosing whether or not to operate an air conditioner.

In a case where the object “YES” has been chosen here as shown in (b) of FIG. 7, the family message board server 2 notifies the agent server 1 accordingly. Then, upon confirmation of reception of this notification, the appliance-related message determining section 34 refers to the operation-assisted appliance table and obtains a template for an operation screen image for starting the operation of an air conditioner.

Further, the appliance-related message determining section 34 identifies, with reference to an operation authorization table shown in (f) of FIG. 8, an air conditioner (air-conditioning apparatus 6) which at least either the father or the mother, who are partaking conversation with each other, is authorized to operate, among other air conditioners (air-conditioning apparatuses 6) registered as operation-assisted appliances.

Specifically, in this operation authorization table, appliance categories, appliance names, and authorized persons are associated with one another. This makes it possible to, in a case where the operation-assisted appliances are air conditioners, extracts appliances (AIR CONDITIONERS 1 to 3) falling under an appliance category “AIR CONDITIONER” and further extracts, from these appliances, AIR CONDITIONERS 1 and 2, which at least either the father or the mother is authorized to operate.

Then, the appliance-related message determining section 34 generates an operation screen image by reflecting, in the template, AIR CONDITIONERS 1 and 2, which at least either the father or the mother, who are partaking conversation with each other, is authorized to operate. This results in such a display as that shown in (c) of FIG. 7.

In an example screen image shown in (c) of FIG. 7, an operation screen image (operation-assisting information) for controlling an air conditioner is being displayed instead of the posting shown in (b) of FIG. 7 that prompts the user to choose whether or not to operate an air conditioner. More specifically, objects (AIR CONDITIONER 1 and AIR CONDITIONER 2) for choosing either AIR CONDITIONER 1 or 2 as a target of operation and an object (END) for terminating the operation are being displayed. Further, while a display “COOLING 28° C.” indicative of the settings for operation of the air conditioner and a display of the current indoor temperature are being performed, an object for raising or lowering the temperature setting, an object for starting operation, and an object (FULL) for starting operation at peak power are being displayed.

In a case where the object “FULL” has been chosen here as shown in (c) of FIG. 7, the family message board server 2 notifies the agent server 1 accordingly. Then, upon confirmation of reception of this notification, the appliance-related message determining section 34 notifies the appliance control section 38 accordingly. Upon receiving this notification, the appliance control section 38 instructs the home server 3 to cause the air-conditioning apparatus 6 to start a cooling operation with the temperature setting at 28° C.

Further, the appliance-related message determining section 34 refers to the operation-assisted appliance table, obtains a template for an operation screen image for controlling an air conditioner in operation, and generates an operation screen image by reflecting the current indoor temperature and the current operation settings in this template. This results in such a display as that shown in (d) of FIG. 7.

In an example screen image shown in (d) of FIG. 7, an operation screen image (operation-assisting information) for controlling an air conditioner in operation is being displayed instead of the operation screen image shown in (c) of FIG. 7 for starting the operation of an air conditioner. More specifically, objects (AIR CONDITIONER 1 and AIR CONDITIONER 2) for choosing either AIR CONDITIONER 1 or 2 as a target of operation and an object (END) for terminating the operation are being displayed. Further, while the current indoor temperature and the current operation settings are being displayed, an object (OPERATE) for inputting the termination or start of operation and objects (HEATING), (DEHUMIDIFYING), and (COOLING) for changing the operation settings are being displayed. Moreover, an object for raising or lowering the temperature setting and an object for raising or lowering the humidity setting are being displayed.

In a case where the object “END” has been chosen here as shown in (d) of FIG. 7, the family message board server 2 notifies the agent server 1 accordingly. Then, upon confirmation of reception of this notification, the appliance-related message determining section 34 generates a message combination of an appliance-related message (I'VE STARTED COOLING WITH THE TEMPERATURE SETTING AT 28° C.) and the conversational message (I'M WAITING FOR YOU AT HOME!).

This results in such a posting as that shown in (e) of FIG. 7. In an example screen image shown in (e) of FIG. 7, the conversational message and the appliance-related message are being displayed instead of the operation screen image shown in (d) of FIG. 7.

Since, as described above, the agent server 1 presents operation-assisting information for assistance in operation of an operation-assisted appliance according to the content etc. of a conversation between members, it becomes possible for each member to easily operate the operation-assisted appliance in line with the content of the conversation.

Further, the agent server 1 presents a compact operation screen image in such a form that information indicative of speakers and messages from the speakers are integrated into a single item, as in the usual case of a family message board service where postings are put.

This makes it possible to assist operation in a display form as in the usual case of communication where postings are put, without causing a feeling of strangeness to the members or interfering with conversation.

[Example Presentation 2 of Operation-Assisting Information]

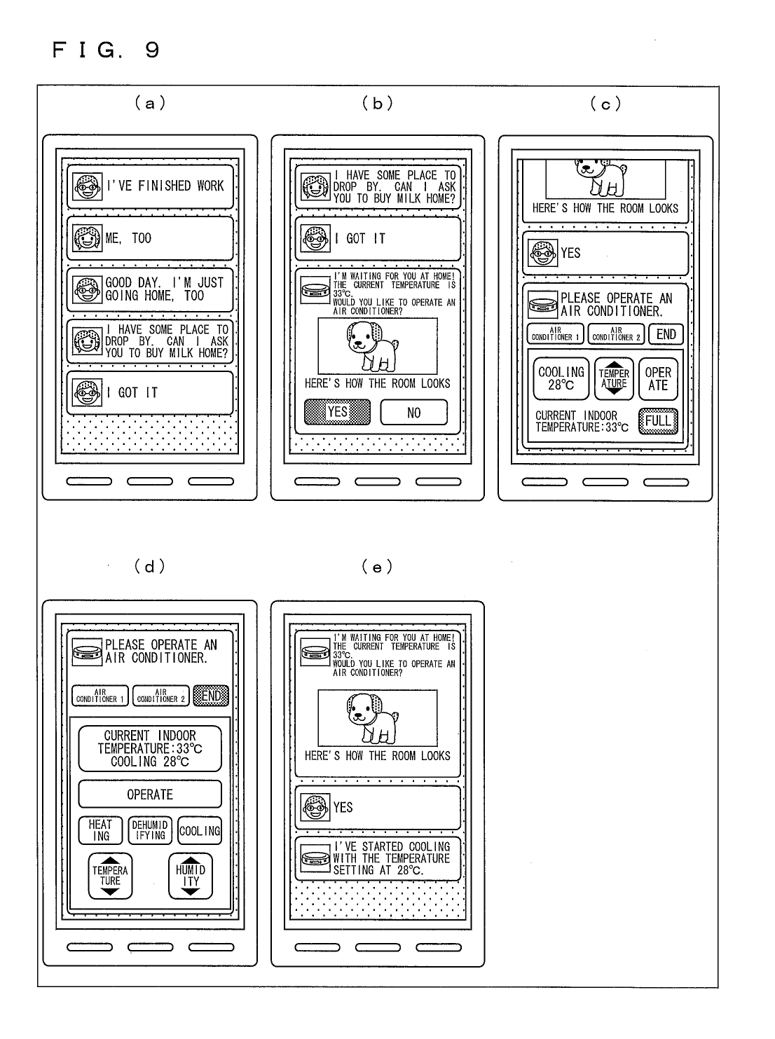

In the example shown in FIG. 7, the content of postings that are put by the agent server 1 is varied in accordance with operation through the operation screen, and a new posting may be added. This is described with reference to FIG. 9. It should be noted that (a), (b), and (d) of FIG. 9 are identical to (a), (b), and (d) of FIG. 7, respectively, and as such, are not described here.

In a case where the object “YES” has been chosen in the operation screen image shown in (b) of FIG. 9, the family message board server 2 notifies the agent server 1 accordingly. Then, upon confirmation of reception of this notification, the appliance-related message determining section 34 generates the selected characters “YES” as a message that is written by the member (in this example, the father) who has chosen the characters “YES”.

Further, the appliance-related message determining section 34 finishes displaying the objects “YES” and “NO” shown in (b) of FIG. 9. Furthermore, the appliance-related message determining section 34 causes an operation screen image for starting operation to be displayed in the same way as in the example shown in FIG. 7.

This erases the objects “YES” and “NO” from the massage from the cleaning robot 5 as written in (b) of FIG. 9, as shown in (c) of FIG. 9. Then, a message “YES” is displayed as a posting that is newly put by the father, and an operation screen image containing a message “PLEASE OPERATE AN AIR CONDITIONER” from the cleaning robot 5 is displayed as still another posting.

Further, in a case where the object “END” has been chosen in the operation screen image shown in (d) of FIG. 9, the family message board server 2 notifies the agent server 1 accordingly. Then, upon confirmation of reception of this notification, the appliance-related message determining section 34 generates an appliance-related message (I'VE STARTED COOLING WITH THE TEMPERATURE SETTING AT 28° C.) indicative of the content of operation received.

This results in such a posting as that shown in (e) of FIG. 9. In an example screen image shown in (e) of FIG. 9, the appliance-related message (I'VE STARTED COOLING WITH THE TEMPERATURE SETTING AT 28° C.) is being displayed instead of the operation screen image shown in (d) of FIG. 9.

In (c) of FIG. 9, the objects “YES” and “NO” has been erased from the messages written. This is intended to avoid concurrence of operations among a plurality of member due to another member starting an operation by utilizing this object.

[Example Presentation 3 of Operation-Assisting Information]

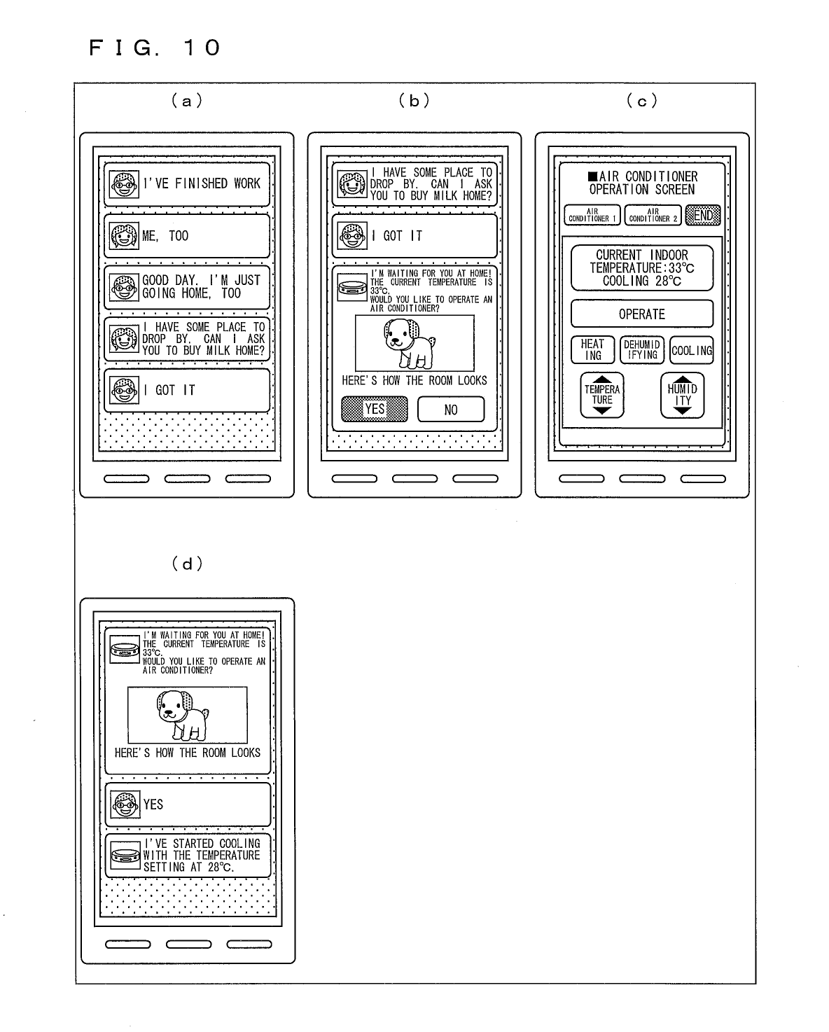

In the following, still another example screen transition concerning a display of operation-assisting information is described with reference to FIG. 10. FIG. 10 is a diagram showing still another example screen transition concerning a display of operation-assisting information. It should be noted that (a), (b), and (d) of FIG. 10 are identical to (a), (b), and (d) of FIGS. 7 and 9, respectively, and as such, are not described here.

In an example screen image shown in (c) of FIG. 10, an operation screen image for controlling an air conditioner is being displayed as a separate window from the family message board. Such an operation screen image may be generated by the appliance-related message determining section 34 and transmitted by the message transmitting section 37 to the family message board server 2 so as to be displayed, or may be transmitted directly to the portable terminals 4a to 4c, without passing through the family message board server 2, so as to be displayed.

[Another Example of Domestic Appliance Operation]

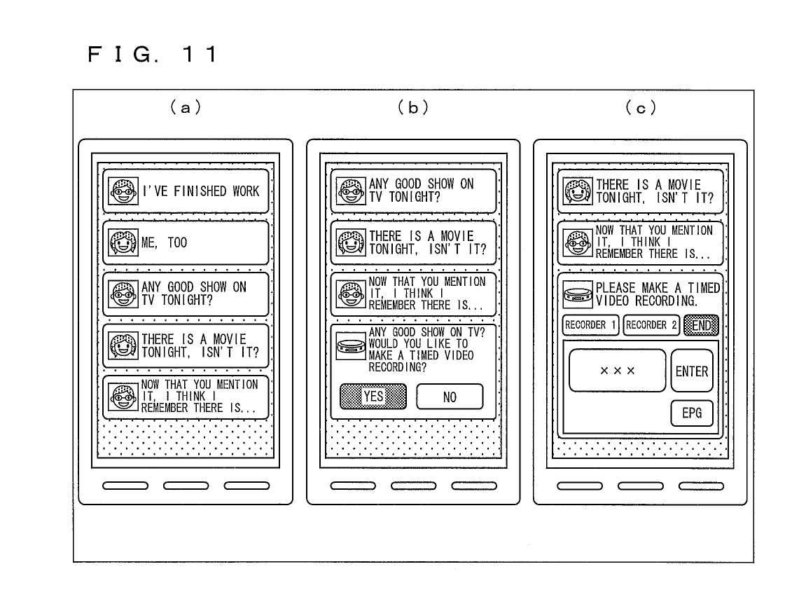

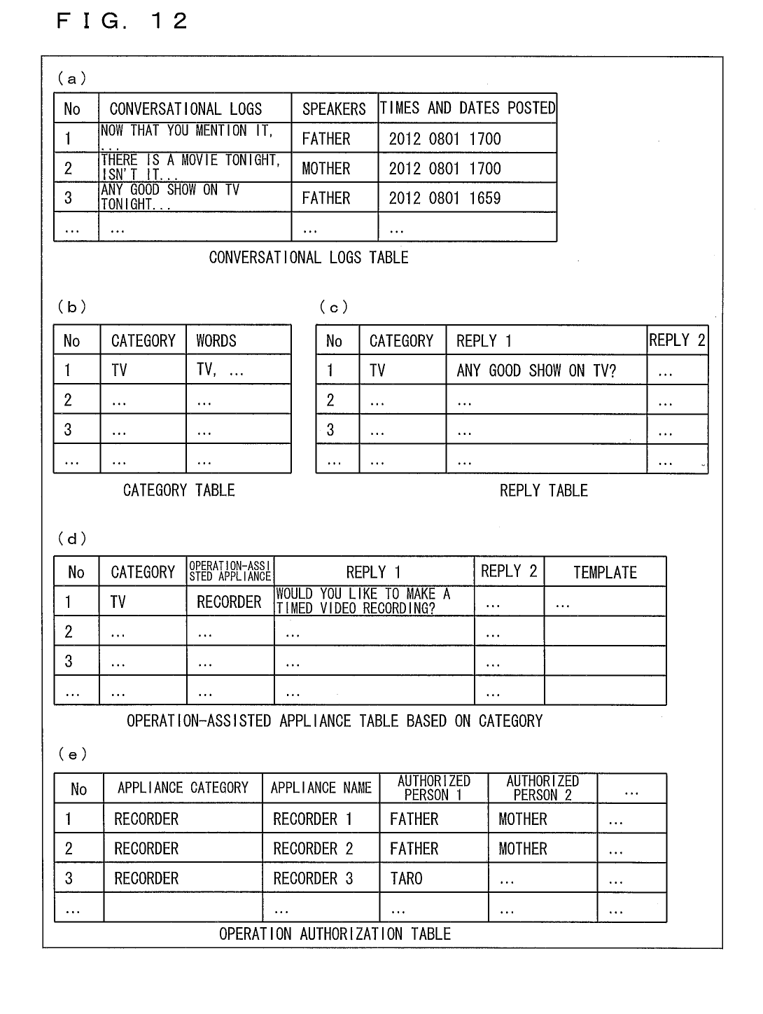

Next, another example of domestic appliance operation is described with reference to FIGS. 11 and 12. FIG. 11 is a diagram showing an example screen transition concerning a display of operation-assisting information on a video recorder 9. Further, FIG. 12 is a diagram showing examples of data stored in the memory section 20 for the agent server 1 to cause the display of the example shown in FIG. 11 to be performed.

In an example screen image shown in (a) of FIG. 11, the father and the mother are having a conversation with each other on the family message board. The content (messages, the speakers who posted the messages, and the times and dates the messages were posted) of this conversation is stored in the conversational log storage section 21 in the form of such a conversational log table as that shown in (a) of FIG. 12.

Since a word “TV” is contained in a conversational log in the conversational log table, the conversational message determining section 33 judges, from a category table shown in (b) of FIG. 12, that the ongoing conversation falls under a category “TV”.

Then, the conversational message determining section 33 randomly extracts, from a reply table shown in (c) of FIG. 12, a reply message falling under the category “TV”. Let it be assumed here that a conversational message “ANY GOOD SHOW ON TV?” was extracted.

Meanwhile, the appliance-related message determining section 34 refers to an operation-assisted appliance table shown in (d) of FIG. 12 and determines, as an operation-assisted appliance, a recorder (video recorder 9) associated with the category “TV”. Let it be assumed here that the appliance-related message determining section 34 referred to the appliance information storage section 10 but no appliance information was stored which makes it necessary to display an appliance-related message.

Next, the appliance-related message determining section 34 confirms, with reference to an operation authorization table shown in (e) of FIG. 12, whether at least either the father or the mother, who are partaking conversation with each other, is authorized to operate the recorder. In a case where neither of them is authorized to operate the recorder, the appliance-related message determining section 34 discontinues the generation of an appliance-related message. In this case, only the conversational message is written.

Alternatively, in a case where at least either of them is authorized to operate the recorder, the appliance-related message determining section 34 extracts a message (appliance-related message) randomly extracted from among reply messages associated with “RECORDER” and a template for choosing whether or not to make a timed video recording, and transmits the message and the template to the message generating section 35.

Then, the message generating section 35 arranges the conversational message and the appliance-related message on the template for choosing whether or not to make a timed video recording, and instructs the message transmitting section 37 to cause the conversational message and the appliance-related message to be written in this layout.

As a result, as shown in (b) of FIG. 11, a template having the messages “ANY GOOD SHOW ON TV?” and “WOULD YOU LIKE TO MAKE A TIMED VIDEO RECORDING?” arranged thereon is displayed on the family message board. This template contains the objects (operation-assisting information) “YES” and “NO” for choosing whether or not to make a timed video recording.

In a case where the object “YES” has been chosen here, the family message board server 2 notifies the agent server 1 accordingly. Then, upon confirmation of reception of this notification, the appliance-related message determining section 34 refers to the operation-assisted appliance table and obtains a template for an operation screen image for making a timed video recording.

Further, the appliance-related message determining section 34 identifies, with reference to the operation authorization table shown in (e) of FIG. 12, a recorder which the member (here, the father) who has chosen “YES” is authorized to operate, among other recorders registered as operation-assisted appliances. That is, RECORDERS 1 and 2 are extracted here.

Then, the appliance-related message determining section 34 generates an operation screen image by reflecting RECORDERS 1 and 2 in the template. This results in such a display as that shown in (c) of FIG. 11.

In an example screen image shown in (c) of FIG. 11, an operation screen image (operation-assisting information) for controlling a recorder is being displayed instead of the posting shown in (b) of FIG. 11 that prompts the user to choose whether or not to make a timed video recording. This allows the members (here, the father and the mother) who are partaking in conversation with each other on the family message board to make a timed video recording by performing an operation on an operation screen image displayed as a posting on the family message board.

The content of the operation performed on the operation screen image is transmitted from the family message board server 2 to the agent server 1. Then, the appliance control section 38 gives an operating instructions to the home server 3 in accordance with the content of the operation so that the timed video recording is executed by the video recorder 9.

In the above example, a message that recommends making a timed video recording is generated. However, a message that recommends a TV program may be generated. In this case, an operation screen image for controlling a TV is displayed.

Further, in a case where someone (such as a friend) other than the members of the family is registered in the family message board service, it is possible to display different operation screen images according to the operators. For example, it is possible to display, to the members of the family, an operation screen image for controlling the TV 8 and display, to a member outside the family, an operation screen image for controlling a TV registered in advance for that member.

[Still Another Example of Domestic Appliance Operation]

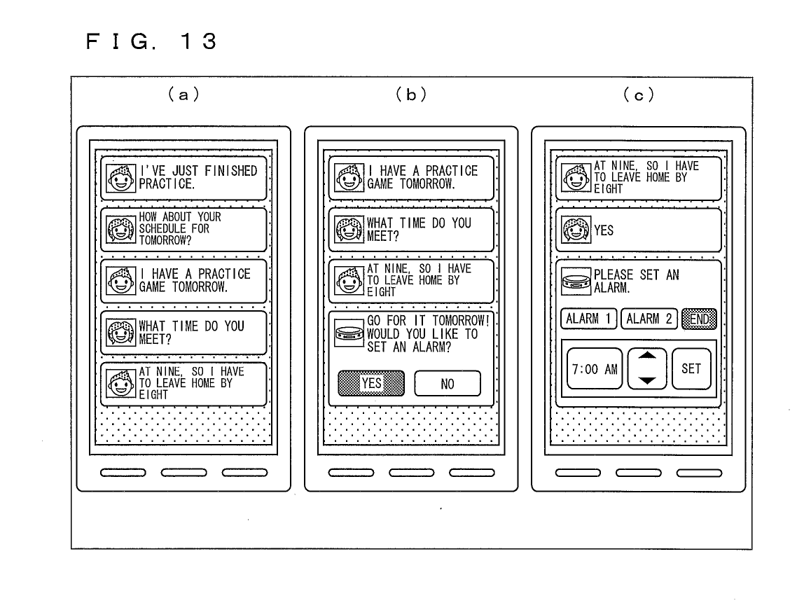

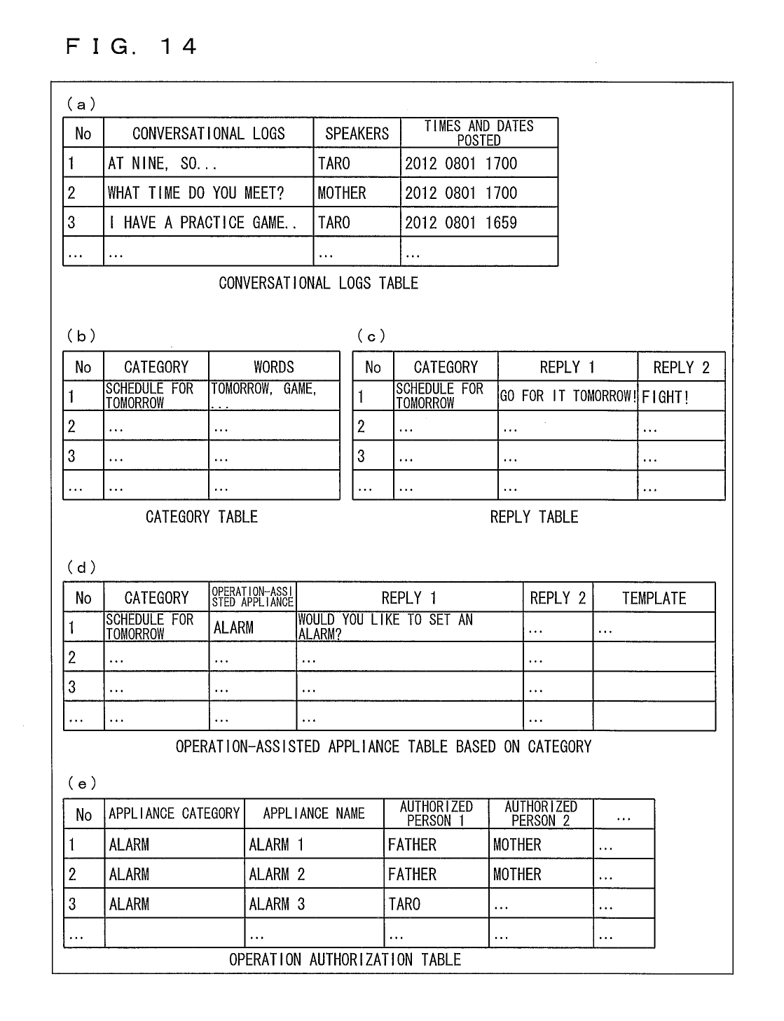

Next, still another example of domestic appliance operation is described with reference to FIGS. 13 and 14. FIG. 13 is a diagram showing an example screen transition concerning a display of operation-assisting information on an appliance capable of making alarm sounds at a designated time. FIG. 14 is a diagram showing examples of data stored in the memory section 20 for the agent server 1 to cause the display of the example shown in FIG. 13 to be performed.

In an example screen image shown in (a) of FIG. 13, the mother and the child are having a conversation with each other on the family message board. The content (messages, the speakers who posted the messages, and the times and dates the messages were posted) of this conversation is stored in the conversational log storage section 21 in the form of such a conversational log table as that shown in (a) of FIG. 14.

Since words “TOMORROW” and “GAME” are contained in a conversational log in the conversational log table, it is judged, from a category table shown in (b) of FIG. 14, that the ongoing conversation falls under a category “SCHEDULE FOR TOMORROW”.

Then, the conversational message determining section 33 randomly extracts, from a reply table shown in (c) of FIG. 14, a reply message falling under the category “SCHEDULE FOR TOMORROW”. Let it be assumed here that a conversational message “GO FOR IT TOMORROW!” was extracted.

Meanwhile, the appliance-related message determining section 34 refers to an operation-assisted appliance table shown in (d) of FIG. 14 and determines, as an operation-assisted appliance, an alarm associated with the category “SCHEDULE FOR TOMORROW”. Let it be assumed here that the appliance-related message determining section 34 referred to the appliance information storage section 10 but no appliance information was stored which makes it necessary to display an appliance-related message.

The alarm, which is an operation-assisted appliance, here is an appliance that emits sound and/or light at a preset time to tell that the preset time has come. For example, the TV 8 shown in FIG. 2 can be used as an alarm. Of course, a domestic appliance other than those shown in FIG. 2 may be used as an alarm.

Further, the appliance-related message determining section 34 confirms, with reference to an operation authorization table shown in (e) of FIG. 14, whether at least either the mother or Taro, who are partaking conversation with each other, is authorized to operate an alarm. In a case where neither of them is authorized to operate an alarm, the appliance-related message determining section 34 discontinues the generation of an appliance-related message. In this case, only the conversational message is written.

Alternatively, in a case where at least either of them is authorized to operate an alarm, the appliance-related message determining section 34 extracts a message (appliance-related message) randomly extracted from among reply messages associated with “ALARM” and a template for choosing whether or not to set an alarm, and transmits the message and the template to the message generating section 35.

Then, the message generating section 35 arranges the conversational message and the appliance-related message on the template for choosing whether or not to set an alarm, and instructs the message transmitting section 37 to cause the conversational message and the appliance-related message to be written in this layout.

As a result, as shown in (b) of FIG. 13, a template having the messages “GO FOR IT TOMORROW!” and “WOULD YOU LIKE TO SET AN ALARM?” arranged thereon is displayed on the family message board. This template contains the objects (operation-assisting information) “YES” and “NO” for choosing whether or not to set an alarm.

In a case where the object “YES” has been chosen here, the family message board server 2 notifies the agent server 1 accordingly. Then, upon confirmation of reception of this notification, the appliance-related message determining section 34 refers to the operation-assisted appliance table and obtains a template for an operation screen image for setting an alarm.

Further, the appliance-related message determining section 34 identifies, with reference to the operation authorization table shown in (e) of FIG. 14, an alarm which the member (here, the mother) who has chosen “YES” is authorized to operate, among other alarms registered as operation-assisted appliances. That is, ALARMS 1 and 2 are extracted here.

Then, the appliance-related message determining section 34 generates an operation screen image by reflecting ALARMS 1 and 2 in the template. This results in such a display as that shown in (c) of FIG. 13.

In an example screen image shown in (c) of FIG. 13, the appliance-related message determining section 34 and the message transmitting section 37 causes a posting “YES” to be put under the name of the mother in order to indicate that the mother has chosen “YES” in the screen image shown in (b) of FIG. 13.

Further, a screen image (operation-assisting information) for setting an alarm is being displayed instead of the posting shown in (b) of FIG. 13 that prompts the user to choose whether or not to set an alarm. This allows the mother to set an alarm by performing an operation on a setting screen image displayed as a posting on the family message board.

[Flow of a Process]

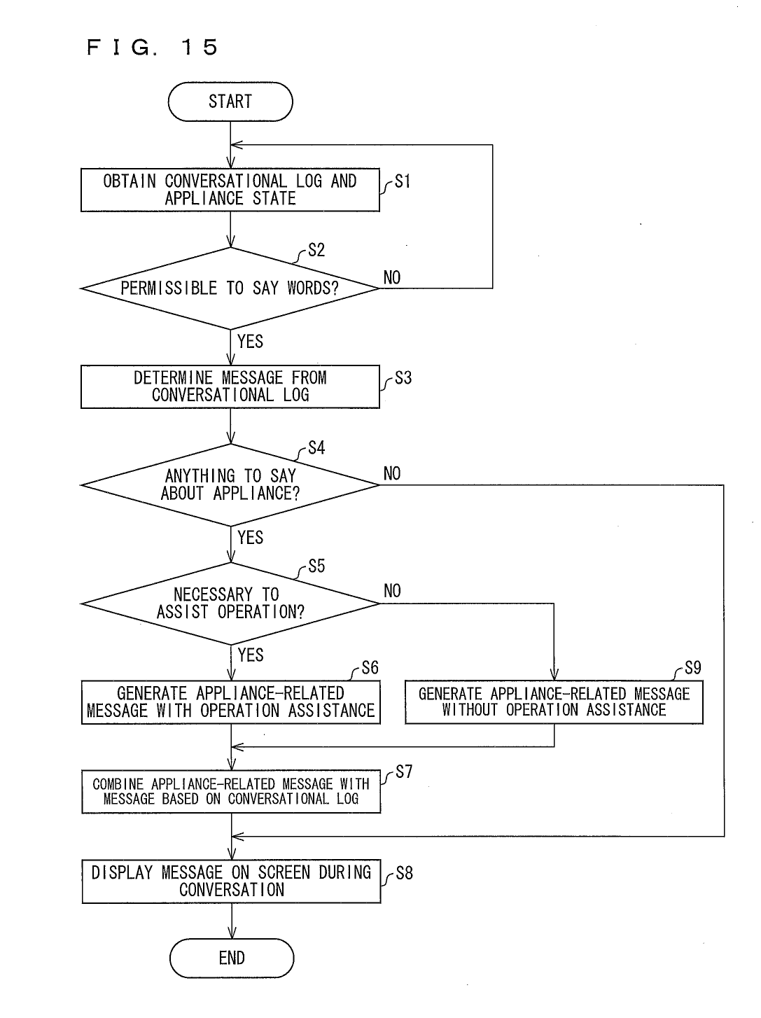

Next, the flow of a process that the agent server 1 executes is described with reference to FIG. 15. FIG. 15 is a flow chart showing an example of a process (operation-assisting method) that the agent server 1 executes.

First, the agent server 1 obtains a conversational log and appliance states (S1). Specifically, the appliance information gathering section 30 obtains, from the home server 3, appliance information indicative of the appliance states of the cleaning robot 5 and the domestic appliances, and the user information gathering section 31 obtains a conversational log from the family message board server 2. It should be noted that step S1 is executed periodically (for example, every two minutes), and the appliance information thus obtained is stored in the appliance information storage section 10, and the conversational log is stored in the conversational log storage section 21.

Next, the judging section 32 judges, with reference to the conversational log stored in the conversational log storage section 21, whether or not it is permissible to say words (S2). It should be noted that this judgment is made at a timing when the storage of the conversational log and the appliance information obtained in S1 is finished.

Specifically, the judging section 32 refers to the conversational log storage section 21 and, in a case where a word was said during a given period of time in the past (for example, from two minutes ago till the present), judges that it is permissible to say words or, in a case where no word was said, judges that it is impermissible to say words.

It should be noted that the method for judging whether or not it is permissible to say words is not limited this. For example, in a case where it is estimated, as a result of an analysis of the conversational log, that the ongoing conversation is of high importance (for example, in a case where a word such as “important” or “serious” is included in the conversation), it possible to judge that it is impermissible to say words.

In a case where it has been judged here that it is impermissible to say words (NO in S2), the process returns to step S1. Alternatively, in a case where it has been judged here that it is permissible to say words (YES in S2), the judging section 32 instructs the conversational message determining section 33 to generate a conversational message.

Upon receiving this instruction, the conversational message determining section 33 reads out the conversational log from the conversational log storage section 21 and determines a conversational message from the conversational log(S3, response determining step). Specifically, first, the conversational message determining section 33 carries out a morphological analysis on the conversational log by decomposing the conversational log into words. Next, with reference to the category table stored in the conversational message generating information storage section 22, the conversational message determining section 33 identifies a category associated with any of these words. Then, with reference to the reply table stored in the conversational message generating information storage section 22, the conversational message determining section chooses a conversational message from among the conversational messages associated with the category thus identified.

Having thus determined a conversational message, the conversational message determining section 33 notifies the message generating section 35 of the conversational message thus determined, and notifies the appliance-related message determining section 34 of the category thus identified.

Next, upon receiving a result of the morphological analysis, the appliance-related message determining section 34 judges whether or not there is anything to say about any of the appliances (S4).

Specifically, the appliance-related message determining section 34 confirms, with reference to the appliance state table and the appliance-related reply table ((b) and (e) of FIG. 6) both stored in the appliance-related message generating information storage section 23, the presence or absence of an appliance-related message corresponding to a numerical value indicative of the state of any of the domestic appliances or the cleaning robot 5.

Further, the appliance-related message determining section 34 confirms, with reference to the operation-assisted appliance table ((e) of FIG. 8, (d) of FIG. 12, or (d) of FIG. 14) stored in the appliance-related message generating information storage section 23, the presence or absence of an appliance-related message corresponding to the category of which the appliance-related message determining section 34 was notified.

Then, in a case where it has been confirmed, as a result of these confirmations, that there is an appliance-related message, it is judged that there is something to say. However, even in a case where there is an appliance-related message in the operation-assisted appliance table, it is judged that there is nothing to say, if it has been conformed that none of the speakers on the conversational log table is authorized to operate the operation-assisted appliance. Further, in a case where the operation-assisted appliance is an air conditioner, it is judged that there is nothing to say, if at least either of the following conditions is satisfied: (1) the temperature is out of a predetermined range (the temperature is high to the extent that cooling is necessary or the temperature is low to the extent that heating is necessary); and (2) there is a pet in the room.

In a case where the appliance-related message determining section 34 has judged here that there is nothing to say (NO in S4), the appliance-related message determining section 34 notifies the message generating section 35 accordingly. Upon receiving this notification, the message generating section 35 generates, as a conversational message composed of a character string that can be written on the family message board, the conversational message determined by the conversational message determining section 33, and transmits the conversational message to the timing-of-saying determining section 36.

Then, the timing-of-saying determining section 36 sends the conversational message to the message transmitting section 37 at a timing when the conversational message should be written, so that the conversational message is written on the family message board. This causes the conversational message to be displayed on the screen image of the family message board during the conversation (S8), whereby the process ends.

It should be noted that the timing when the conversational message should be written is determined according to the situation of writing on the family message board. Specifically, in a case where a plurality of members are writing messages on the family message board, the timing-of-saying determining section 36 causes the conversational message to be written at a timing when the following two conditions have been satisfied, so as not to inhibit conversation among the members: (1) a predetermined period of time (for example, 30 seconds) or more has elapsed since the time when the most recent message was written; and (2) the number of messages written within a predetermined period of time backward from the current time.

This allows the agent server 1 to write a message only at the time of interruption of a conversation among members, thus preventing the agent server 1 from inhibiting the conversation among the members. Further, this prevents the agent server 1 from breaking into a conversation when the conversation is charged up. In a case where there is only one member writing a message, such consideration is unnecessary and therefore the timing-of-saying determining section 36 causes the conversational message to be transmitted and displayed right away.

Alternatively, in a case where the appliance-related message determining section 34 has judged here that there is something to say (YES in S4), the appliance-related message determining section 34 judges whether or not it is necessary to assist operation (S5). Specifically, in a case where it has been confirmed that an appliance-related message to be written is present in the operation-assisted appliance table, the appliance-related message determining section 34 judges that it is necessary to assist operation.

In a case where the appliance-related message determining section 34 has judged here in step S5 that it is unnecessary to assist operation (NO in S5), the appliance-related message determining section 34 generates an appliance-related message without operation assistance with reference to the appliance-related reply table (S9), and transmits the appliance-related message to the message generating section 35.

Next, the message generating section 35 combines the conversational message determined in step S3 and the appliance-related message generated in step S6 into a single message (S7), and transmits the message to the timing-of-saying determining section 36. Then, the timing-of-saying determining section 36 sends the message to the message transmitting section 37 at a timing when the message should be written, so that the message is written on the family message board. This causes the single message containing the conversational message and the appliance-related message to be displayed on the screen image of the family message board during the conversation (S8), whereby the process ends.

Alternatively, in a case where the appliance-related message determining section 34 has judged in step S5 that it is necessary to assist operation (YES in S5), the appliance-related message determining section 34 generates an appliance-related message with reference to the operation-assisted appliance table (S6, operation-assisting information obtaining step). Further, the appliance-related message determining section 34 obtains a template for operation assistance from the operation-assisted appliance table, and transmits the template to the message generating section 35 together with the appliance-related message thus generated.

Next, the message generating section 35 combines the conversational message determined in step S3 and the appliance-related message generated in step S6 (S7), generates a message by arranging them on the template, and transmits the message to the timing-of-saying determining section 36. This causes the single message containing the conversational message and the appliance-related message to be displayed on the screen image of the family message board during the conversation (S8, presenting step), whereby the process ends.

In causing an appliance-related message with operation assistance to be displayed, the timing-of-saying determining section 36 determines the timing of transmission of the message according to the urgency of the message. For example, in the case of a pet in a hot room, the urgency of a message that recommends operating an air conditioner is high. Therefore, in a case where the message to be written concerns operation of an air conditioner, the timing-of-saying determining section 36 causes the message to be transmitted and displayed right away. Meanwhile, in the case a message of low urgency, the timing-of-saying determining section 36 determines the timing according to the situation of writing on the family message board, as in a case where only a conversational message is transmitted.

[Modification]

In each of the examples described above, a conversational message is displayed in response to what a member says, and an appliance-related message is displayed as needed together with the conversational message; however, the agent server 1 may be permitted to say words even in a state where there is no word said by a member. That is, the agent server 1 may be configured to spontaneously write a tweet. Moreover, the message that is written at this time may be a conversational message, an appliance-related message, or a combination of both.

Further, in each of the examples described above, a conversational message is determined according solely to the content of a conversation between members, but may alternatively be determined with concomitant use of information other than the content of the conversation. For example, a conversational message may be determined according to the relationship between members. In this case, by registering in advance a conversational message in line with a conversation between husband and wife, the conversational message can be written at a timing when the father and the mother are having a conversation on the family message board.

Furthermore, in this case, by registering in advance the mother's birthday and a conversational message in line with a conversation between husband and wife on the wife's birthday, the conversational message can be written at a timing when the father and the mother are having a conversation on the family message board on the mother's birthday.

In addition to these, it is also possible to register in advance attribute information indicative of the attributes of members, such as ages and sexes, and conversational messages in line with the attribute information and write a conversational message in line with the attributes of members having a conversation on the family message board.

Further, in each of the examples described above, an operation screen image is presented in such a manner that all of the members of the family message board can see it. However, it is possible to instruct the family message board server 2 to present it in such a manner that only a member with operation authorization can see it. Furthermore, it is also possible to change forms of display according to users or terminals.

Similarly, as for a message written by the agent server 1 other than an operation screen image, it is also possible to present the message in such a manner that only a specific member can see it. For example, it is possible to obtain the birthday of a member in collaboration with schedule management software or the like and write a message that presents the birthday only to other members (members other than the member born on the birthday day).

Although the present invention has been described by taking, as an example, a case where the present invention is applied to a family message board service, the present invention can be applied to any service that allows exchange of massages among members, can identify each of the members, and can carry out an analysis of a message. Possible examples of such services include a service such as a chat and a service, such as a TV phone, that allows exchange of messages by means of sounds and images.

[Summary]

An operation-assisting apparatus (agent server 1) according to an aspect of the present invention is an operation-assisting apparatus for assisting operation of an electronic appliance associated with a user of a communications network service that presents a message from a member of a group to another member of the group, including: responding means (conversational message determining section 33) for determining a response message to a target-of-presentation message that is a target of presentation in the service; operation-assisting means (appliance-related message determining section 34) for obtaining, according to the target-of-presentation message operation-assisting information for assisting the operation of the electronic appliance; and presenting means (message transmitting section 37) for causing the response message and the operation-assisting information to be presented to the user on a same screen as the target-of-presentation message.

Further, an operation-assisting method according to an aspect of the present invention is an operation-assisting method that is employed by an operation-assisting apparatus (agent server 1) for assisting operation of an electronic appliance associated with a user of a communications network service that presents a message from a member of a group to another member of the group, including: a response determining step of determining a response message to a target-of-presentation message that is a target of presentation in the service; an operation-assisting information obtaining step of obtaining, according to the target-of-presentation message operation-assisting information for assisting the operation of the electronic appliance; and a presenting step of causing the user with the response message and the operation-assisting information to be presented to the user on a same screen as the target-of-presentation message.

According to the foregoing configuration, a response message to a target-of-presentation message is determined, and operation-assisting information for assisting operation of an electronic appliance is obtained. Then, the response message and the operation-assisting information are presented to a user on the same screen as the target-of-presentation message.

This allows the user to see the target-of-presentation message, the response message, and the operation-assisting information on the same screen. That is, the user can see the target-of-presentation message and the response message thereto, and can operate an electronic appliance with use of the operation-assisting information as needed.

This makes it possible to present a response message in line with a target-of-presentation message and to easily operate an electronic appliance in line with the target-of-presentation message.

Furthermore, the operation-assisting method according to an aspect of the present invention may be configured to further include state obtaining means (appliance information gathering section 30) for obtaining state information that indicates a state concerning the electronic appliance associated with the user, wherein in a case where it is judged, from the state information obtained by the state information obtaining means, that it is necessary to operate the electronic appliance, the operation-assisting means obtains the operation-assisting information for assisting the operation of the electronic appliance.

According to the foregoing configuration, state information that indicates a state concerning an electronic appliance is obtained, and in a case where it is judged, from the state information thus obtained, that it is necessary to operate the electronic appliance, operation-assisting information for assisting operation of the electronic appliance is obtained.

This makes possible to present operation-assisting information at an appropriate timing according to a state concerning an electronic appliance. It should be noted that the term “state concerning an electronic appliance” means a state of the electronic appliance per se or a state of an area around the electronic appliance.

Further, the operation-assisting method according to an aspect of the present invention may be configured to further include state obtaining means for obtaining state information that indicates a state of the electronic appliance associated with the user, wherein the presenting means causes the response message and a state-related message to be presented to the user on a same screen as the target-of-presentation message, the state-related message having been determined in advance according to the state that is indicated by the state information obtained by the state obtaining means.

According to the foregoing configuration, state information that indicates a state concerning an electronic appliance associated with a user, and a response message and a state-related message are presented to the user on the same screen as a target-of-presentation message.

This allows a user to recognize a state concerning an electronic appliance during communication.

Further, the operation-assisting method according to an aspect of the present invention may be configured such that the presenting means causes the response message and the operation-assisting information to be presented in a case where a number of target-of-presentation messages within a predetermined period of time is less than a predetermined upper limit.

According to the foregoing configuration, a response message and operation-assisting information are presented in a case where the number of target-of-presentation messages within a predetermined period of time is less than a predetermined upper limit. This makes it possible to prioritize communication between members and to prevent inhibition of a conversation between members when the conversation is charged up.

The operation-assisting apparatus may be realized by computer. In this case, a control program which causes a computer to operate as each means of the operation-assisting apparatus and thereby causing the operation-assisting apparatus to be realized by computer and a computer-readable recording medium containing such a control program are also encompassed in the scope of the present invention.

The present invention is not limited to the description of the embodiments above, but may be altered by a skilled person within the scope of the claims. An embodiment based on a proper combination of technical means disclosed in different embodiments is encompassed in the technical scope of the present invention. Further, a new technical idea can be formed by combining technical features described in the embodiments of the present invention.

[Examples of Embodiments by Software]

Finally, the blocks, especially the control section 11, of the agent server 1 may be realized by way of hardware by logic circuits formed on an integrated circuit (IC chip), or may be realized by way of software as executed by a CPU (central processing unit).

In the latter case, the agent server 1 includes a CPU and memory devices (memory media). The CPU executes instructions in control programs realizing the functions. The memory devices include a ROM (read only memory) which contains programs, a RAM (random access memory) to which the programs are loaded, and a memory containing the programs and various data. The objective of the present invention can also be achieved by mounting to the agent server 1 a computer-readable storage medium containing control program code (executable program, intermediate code program, or source program) for the agent server 1, which is software realizing the aforementioned functions, in order for the computer (or CPU, MPU) to retrieve and execute the program code contained in the storage medium.

The recording medium may be, for example, a tape, such as a magnetic tape or a cassette tape; a disk, such as a magnetic disk, such as a floppy (Registered Trademark) disk or a hard disk, or an optical disk, such as CD-ROM/MO/MD/DVD/CD-R; a card, such as an IC card (memory card) or an optical card; a semiconductor memory, such as a mask ROM/EPROM/EEPROM/flash ROM; or a logic circuit, such as a PLD (programmable logic device or an FPGA (field programmable gate array).

The agent server 1 may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, wired line, such as IEEE 1394, USB, electric power line, cable TV line, telephone line, or ADSL (Asymmetric Digital Subscriber Line) line; or wireless, such as infrared radiation (IrDA, remote control), Bluetooth, 802.11 wireless, HDR (High Data Rate), NFC (Near Field Communication), DLNA (Digital Living Network Alliance), mobile telephone network, satellite line, or terrestrial digital network. The present invention encompasses a carrier wave or data signal transmission in which the program code is embodied electronically.

### INDUSTRIAL APPLICABILITY

The present invention is applicable to a service that provides exchange of messages etc. through a communications network.

### REFERENCE SIGNS LIST

1 Agent server (operation-assisting apparatus)
30 Appliance information gathering section (state obtaining means)
33 Conversational message determining section (responding means)
34 Appliance-related message determining section (operation-assisting means)
37 Message transmitting section (presenting means)

1. An operation-assisting apparatus for assisting operation of an electronic appliance associated with a user of a communications network service that presents a message from a member of a group to another member of the group, comprising:
responding means for determining a response message to a target-of-presentation message that is a target of presentation in the service;
operation-assisting means for obtaining, according to the target-of-presentation message, operation-assisting information for assisting the operation of the electronic appliance; and
presenting means for causing the response message and the operation-assisting information to be presented to the user on a same screen as the target-of-presentation message.

2. The operation-assisting apparatus as set forth in claim 1, further comprising state obtaining means for obtaining state information that indicates a state of the electronic appliance associated with the user, wherein
in a case where it is judged, from the state information obtained by the state information obtaining means, that it is necessary to operate the electronic appliance, the operation-assisting means obtains the operation-assisting information for assisting the operation of the electronic appliance.

3. The operation-assisting apparatus as set forth in claim 1, further comprising state obtaining means for obtaining state information that indicates a state of the electronic appliance associated with the user, wherein
the presenting means causes the response message and a state-related message to be presented to the user on a same screen as the target-of-presentation message, the state-related message having been determined in advance according to the state that is indicated by the state information obtained by the state obtaining means.

4. The operation-assisting apparatus as set forth in claim 1, wherein the presenting means causes the response message and the operation-assisting information to be presented in a case where a number of target-of-presentation messages within a predetermined period of time is less than a predetermined upper limit.

5. An operation-assisting method that is employed by an operation-assisting apparatus for assisting operation of an electronic appliance associated with a user of a communications network service that presents a message from a member of a group to another member of the group, comprising:
a response determining step of determining a response message to a target-of-presentation message that is a target of presentation in the service;
an operation-assisting information obtaining step of obtaining, according to the target-of-presentation message operation-assisting information for assisting the operation of the electronic appliance; and
a presenting step of causing the response message and the operation-assisting information to be presented to the user on a same screen as the target-of-presentation message.

6. A computer-readable non-transitory recording medium containing a control program for operating an operation-assisting apparatus for assisting operation of an electronic appliance associated with a user of a communications network service that presents a message from a member of a group to another member of the group, the control program causing a compute to execute:
a response determining step of determining a response message to a target-of-presentation message that is a target of presentation in the service;
an operation-assisting information obtaining step of obtaining, according to the target-of-presentation message, operation-assisting information for assisting the operation of the electronic appliance; and
a presenting step of causing the response message and the operation-assisting information to be presented to the user on a same screen as the target-of-presentation message.
